(19) United States
(12) Patent Application Publication
(10) Pub. No.: US 2014/0010993 A1
(43) Pub. Date: Jan. 9, 2014

(54) DECORATION FILM AND METHOD FOR MANUFACTURING DECORATED ARTICLE

(71) Applicant: ETANSI INC., Taoyuan County (TW)

(72) Inventors: Pin-Hau Chiu, Taoyuan County (TW); Shu-Yin Cheng, Taoyuan County (TW)

(73) Assignee: ETANSI INC., Taoyuan County (TW)

(21) Appl. No.: 13/659,931

(22) Filed: Oct. 25, 2012

(30) Foreign Application Priority Data
Jul. 4, 2012 (TW) 101124051

(51) Int. Cl. B32B 3/30; B32B 27/04; B29C 39/36; B32B 5/16

(52) U.S. Cl. 428/143; 428/182; 428/141; 264/334

(57) ABSTRACT

A decoration film and a method for manufacturing a decorated article are provided. The decoration film includes a supporting layer and a releasing layer. The releasing layer is disposed on the supporting layer. Here, a releasing material of the releasing layer includes extendable resin and a plurality of particles, and a side of the releasing layer, away from the supporting layer, has an undulating surface.

### CROSS-REFERENCE TO RELATED APPLICATION

This application claims the priority benefit of Taiwan application serial no. 101124051, filed on Jul. 4, 2012. The entirety of the above-mentioned patent application is hereby incorporated by reference herein and made a part of this specification.

### BACKGROUND OF THE INVENTION

1. Field of Invention

The invention relates to a decoration film and a method for manufacturing a decorated article. More particularly, the invention relates to a decoration film in which a releasing layer has an undulating surface and a method for manufacturing a decorated article.

2. Background of the Invention

Conventionally, if it is intended to paint or decorate a plastic housing of any electronic product, patterns are often sprayed or printed onto the surface of the housing, so as to equip with the housing with different colors or designs. The conventional spray coating process, however, consumes significant time and requires complicated procedures, which is not conducive to mass production. Besides, the conventional spray coating process may generate considerable lead-containing or heavy-metal-containing mist, which not only leads to waste of spray paint but also results in environmental pollution. From another perspective, during the spray coating process, the inconsistent mass of spray paint on different regions may result in uneven thickness of the coating. Particularly, when the spray coating process is performed on curved portions of the housing, the paint material is often improperly accumulated thereon.

To resolve such issue, an in-mold roller (IMR) molding technology has been developed. By applying the IMR molding technology, film layers with different functions are sequentially coated or printed onto a supporting layer to form a decoration film with decorative design. The decoration film is then placed into a mold for performing an injection molding process. A thermally melted resin (or a plastic material) is injected at a side of the decoration film in the mold, such that the thermally melted resin and the film layers of the decoration film may be combined to form a decorated article. An ejection process is then performed to remove the decorated article from the mold. Thereby, the IMR molding process is completely performed.

Owing to a user's increasing demands for exterior design, the decorated article is required to both achieve certain visual effects and evoke the user's touch sensation of texture. Hence, more film layers with different functions need to be formed on the supporting layer, and the stacked film layers increase the thickness of the decoration film. The increase in the thickness of the decoration film raises the manufacturing costs, increases the labor hours, and poses more limitations on the supporting layer. Moreover, the characteristics of extensibility and coverage of the decorated article are restrained, and the design tolerance of edges and corner angles of the decorated article is reduced.

### SUMMARY OF THE INVENTION

The invention is directed to a decoration film with small thickness.

The invention is further directed to a method for manufacturing a decorated article. The decorated article has favorable exterior design tolerance and is suitable for mass production.

In an embodiment of the invention, a decoration film that includes a supporting layer and a releasing layer is provided. The releasing layer is disposed on the supporting layer. Here, a releasing material of the releasing layer includes extendable resin and a plurality of particles, and a side of the releasing layer, away from the supporting layer, has an undulating surface.

According to an embodiment of the invention, the decoration film further includes a rough layer, and the supporting layer and the releasing layer are located at two respective sides of the rough layer.

According to an embodiment of the invention, the rough layer is a haze layer, a three-dimensional (3D) plastic layer, or a stacked layer containing the haze layer and the 3D plastic layer.

According to an embodiment of the invention, the haze layer includes a plurality of haze particles, and the haze particles equip a first side of the haze layer, away from the supporting layer, with an undulating haze surface. The releasing layer is substantially conformally formed on the first side of the haze layer, so as to form the undulating surface.

According to an embodiment of the invention, the haze layer further includes a matrix and a material of the matrix is selected from the group consisting of polyurethane, polymethylmethacrylate, epoxide, and polyester.

According to an embodiment of the invention, a material of the 3D plastic layer is selected from polyurethane resin (i.e., PU resin), melamine resin, or a mixture of PU resin and melamine resin. A second side of the 3D plastic layer away from the supporting layer has an undulating 3D surface, and the releasing layer is substantially conformally formed on the second side of the 3D plastic layer, so as to form the undulating surface.

According to an embodiment of the invention, the releasing material further includes a haze material selected from the group consisting of polyurethane, polymethylmethacrylate, epoxide, and polyester.

According to an embodiment of the invention, the haze layer further includes a plurality of haze particles, and the haze particles equip the side of the releasing layer, away from the supporting layer, with the undulating surface.

According to an embodiment of the invention, the decoration film further includes a 3D plastic layer, and the supporting layer and the releasing layer are located at two respective sides of the 3D plastic layer.

According to an embodiment of the invention, a material of the releasing layer further includes a material of a 3D plastic layer, and the material of the 3D plastic layer is selected from PU resin, melamine resin, or a mixture of PU resin and melamine resin.

According to an embodiment of the invention, a material of the supporting layer includes polyethylene terephthalate, polycarbonate, polyvinyl chloride, or polymethyl methacrylate.

According to an embodiment of the invention, the particles are selected from the group consisting of silicon dioxide, calcium carbonate, calcium sulfate, barium sulfate, aluminum oxide, and titanium oxide, and a shape of the particles is circular or irregular.

According to an embodiment of the invention, a material of the releasing layer further includes a cross-linking agent and a curing agent.

According to an embodiment of the invention, the extendable resin is PU resin, melamine resin, or a mixture of PU resin and melamine resin.

According to an embodiment of the invention, the cross-linking agent is selected from isocyanate.

According to an embodiment of the invention, the curing agent is selected from epoxy resin.

In an embodiment of the invention, a method for manufacturing a decorated article includes following steps. A releasing material that includes extendable resin, a plurality of particles, a cross-linking agent, and a curing agent is prepared. The releasing material is coated on a supporting layer to form a decoration film. The decoration film includes the supporting layer and a releasing layer that is made of the releasing material, and a side of the releasing layer, away from the supporting layer, has an undulating surface. A body is formed at the side of the releasing layer of the decorative film, and a surface of the body adjacent to the releasing layer is substantially conformed to the side of the releasing layer and is an undulating surface. The entire decorative film is removed away from the body to form a decorated article.

According to an embodiment of the invention, a method of forming the body includes placing a plastic material at the side of the releasing layer away from the supporting layer, and the plastic material is solidified to form the body.

According to an embodiment of the invention, the plastic material is selected from the group consisting of polycarbonate, polypropylene, polymethylmethacrylate, MMA-St, acrylonitrile butadiene styrene (ABS), polystyrene, polyethylene terephthalate, and polyoxymethylene.

According to an embodiment of the invention, the surface of the body adjacent to the releasing layer has an undulating height difference which at least reaches about 40 μm.

In view of the above, the decoration film with relatively fewer film layers is provided herein, and the decorated article having the undulating surface structure is formed with use of such decoration film. Here, the corner design of the decorated article is not limited to round angles, and therefore the exterior design tolerance of the decorated article is relatively high. In addition, the releasing material of the releasing layer includes a plurality of particles which may enhance the releasing capability of the releasing layer. Accordingly, the decoration film may be completely removed from the plastic body to form the decorated article.

Several exemplary embodiments accompanied with figures are described in detail below to further explain the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 to FIG. 6 are schematic cross-sectional diagrams illustrating different decoration films according to several embodiments of the invention.

FIG. 7A and FIG. 7B are schematic diagrams illustrating a process of manufacturing a decorated article according to an embodiment of the invention.

### DETAILED DESCRIPTION OF DISCLOSED EXEMPLARY EMBODIMENTS

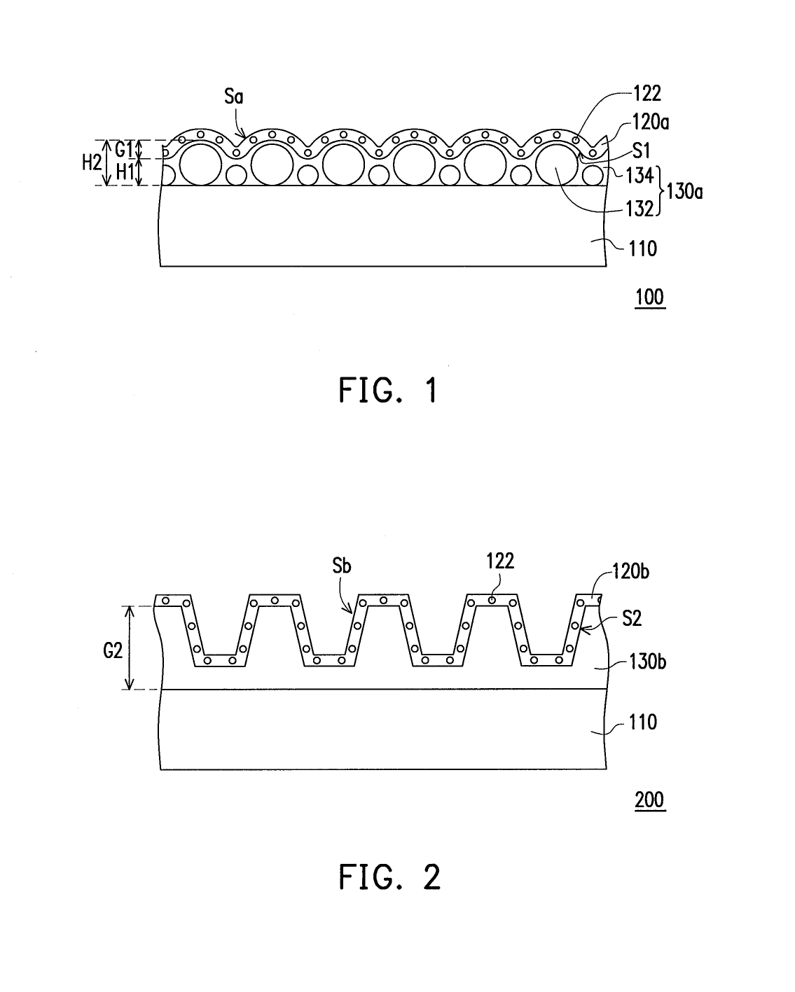

FIG. 1 to FIG. 6 are schematic cross-sectional diagrams illustrating different decoration films according to several embodiments of the invention. With reference to FIG. 1, the decoration film 100 described in the present embodiment includes a supporting layer 110 and a releasing layer 120a. The releasing layer 120a is disposed on the supporting layer 110, and a side of the releasing layer 120a, away from the supporting layer 110, has an undulating surface Sa. A material of the supporting layer 110 includes polyethylene terephthalate, polycarbonate, polyvinyl chloride, or polymethyl methacrylate. A releasing material of the releasing layer 120a includes a plurality of particles 122. In the present embodiment, the material of the particles 122 include silicon dioxide, calcium carbonate, calcium sulfate, barium sulfate, aluminum oxide, delustering wax (polyethylene wax), titanium oxide, or a group consisting of the above materials. Besides, a shape of the particles 122 is circular or irregular, and diameters of the particles 122 range from about 1 μm to about 15 μm. The particles 122 shown in FIG. 1 are schematic, while the distribution of the particles 122 in the releasing layer 120a is not limited in the present embodiment. Besides, whether or not the diameter of each particle 122 is identical is not limited in the present embodiment. The particles 122 in the releasing layer 120a are characterized by abrasion resistance and may serve as an slipping agent. Hence, the particles 122 not only may change the surface roughness of the undulating surface Sa of the releasing layer 120a and allow a user to experience the undulating touch sensation but also may improve the releasing capability of the releasing layer 120a. Moreover, the particles 122 may achieve protection against scratches and abrasions.

In the present embodiment, a material of forming the releasing layer 120a may further include extendable resin (not shown), a cross-linking agent (not shown), and a curing agent (not shown). Here, the extendable resin is melamine resin or any other extendable resin, for instance. It should be mentioned that the characteristics of coverage and extensibility of the releasing layer 120a may be improved by adding the extendable resin to the releasing layer 120a, such that the decorated article formed by applying the decoration film 100 described in the present embodiment may have sharp edges and small corner angles. Namely, the releasing layer 120a employed in the present embodiment may be conducive to improvement of exterior design tolerance of the decorated article. Additionally, the extensibility of the releasing layer 120a may be adjusted based on actual design demands for the article. That is, given that the edges and the corner angles of the decorated article are different, the releasing layer 120a may be formed with use of different extendable resin. The cross-linking agent may be closed-type isocyanate or any other substance that may promote or modulate the formation of molecular bond, covalent bond, or ionic bond in a polymer. The curing agent may be an epoxy resin curing agent or any other substance that may decompose the resin compound to generate free radicals and encourage the bonding action of the resin.

The decoration film 100 may further include a rough layer constituted by a haze layer 130a, and the supporting layer 110 and the releasing layer 120a are located at two respective sides of the rough layer (constituted by the haze layer 130a) in a thickness direction. In another embodiment of the invention, the rough layer 130 may be a three-dimensional (3D) plastic layer or a stacked layer containing the 3D plastic layer and the haze layer.

The haze layer 130a may be formed on the supporting layer 110 through intaglio printing or coating, and the intaglio printing process may be performed by roll-to-roll printing or imprinting. Besides, the haze layer 130a includes a plurality of haze particles 132 and a matrix 134. The haze particles 132 are distributed into the matrix 134. The material of the matrix 134 includes polyurethane, polymethylmethacrylate, epoxide, polyester, or a group consisting of the aforesaid materials. A material of the haze particles 132 may be silicon dioxide, calcium carbonate, calcium sulfate, barium sulfate, aluminum oxide, titanium oxide, metal powder, inorganic paint, or organic paint, and the haze particles 132 may be shaped as hollow balls, non-film-forming latexes, or dispersions. In addition, diameters of the haze particles 132 range from about 0.1 μm to about 30 μm.

The haze particles 132 protrude from the matrix 134, such that a first side S1 of the haze layer 130a away from the supporting layer 110 is equipped with an undulating haze surface (or a rough surface). Here, the haze surface has recessions and protrusions because of the distribution of the haze particles 132. In the present embodiment, the releasing layer 120a is substantially conformed to the first side S1 (i.e., the haze surface) of the haze layer 130a, and therefore the releasing layer 120a has the undulating surface Sa. Additionally, in consideration of different design demands for articles, the haze surface may have recessions and protrusions with different distribution densities by adjusting the distribution of the haze particles 132.

Specifically, because of the haze particles 132, the haze layer 130a may have at least two different thicknesses, i.e., the first thickness H1 and the second thickness H2. Here, the first thickness H1 is greater than the second thickness H2, and thereby a height difference G1 (the difference between the first and the second thicknesses H1 and H2) may be defined. Here, the height difference G1 refers to the undulating depth of the surface structure of the haze layer 130a. Since the releasing layer 120a is substantially conformed to the surface of the haze layer 130a, the releasing layer 120a may substantially provide an undulating structure with the height difference G1. Certainly, due to the different manufacturing parameters, e.g., the thickness of the releasing layer 120a or the manufacturing technique, the undulating depth of the undulating structure of the releasing layer 120a may be slightly smaller than the undulating depth (i.e., the height difference G1) of the surface structure of the haze layer 130a.

Note that the height difference G1 may enable light with different wavelengths to be reflected or refracted in different directions, so as to generate the light gradient effect (e.g., the foggy effect). Hence, the rough layer is named as the haze layer 130a. However, whether or not the undulating portion of the haze surface of the haze layer 130a is spread all over the supporting layer 110 is not limited in the present embodiment. In an embodiment of the invention, through adjustment of the distribution of the haze particles 132, the rough layer may be partially flat (i.e., the height difference G1 is substantially 0) and partially rough (i.e., the height difference G1 is not equal to 0). Besides, the releasing layer 120a is formed on the haze layer 130a through coating, printing, imprinting, or a combination thereof, and the releasing layer 120a is substantially conformed to the first side S1 (i.e., the haze surface) of the haze layer 130a, such that the releasing layer 120a has the undulating surface Sa. Therefore, even though the releasing layer 120a is formed, the decoration film 100 has the undulating surface structure at a side away from the supporting layer 110.

Certainly, whether the haze visual effect or the sensation of rough texture of the decoration film 100 is provided by the haze layer 130a or not is not limited in the invention; in other embodiments of the invention, the rough layer may be replaced by other film layers with different functions, so as to achieve different visual or tactile effects. With reference to FIG. 2, the decoration film 200 described in the present embodiment and the decoration film 100 depicted in FIG. 1 have identical or similar components, and the same or similar reference numbers shown in FIG. 1 and FIG. 2 represent the same or similar components or the same or similar characteristics of the components. The difference therebetween lies in that a 3D plastic layer 130b as the rough layer of the decoration film 200 is employed in the present embodiment. Here, a material of the 3D plastic layer 130b includes PU resin, melamine resin, or a mixture of PU resin and melamine resin, and a second side S2 of the 3D plastic layer 130b away from the supporting layer 110 has an undulating 3D surface. The releasing layer 120b is substantially conformed to the second side S2 (i.e., the 3D surface) of the 3D plastic layer 130b, such that the releasing layer 120b has an undulating surface Sb.

In the present embodiment, the undulating 3D surface may be formed on the 3D plastic layer 130b through an intaglio printing with use of a flat mold or a cylindrical mold with different patterns, for instance, such that the printed 3D plastic layer 130b may have different designs. Alternatively, the undulating 3D surface may be printed onto the 3D plastic layer 130b having different thicknesses through intaglio printing with use of a mold plate having at least two different depths, so that the 3D plastic layer 130b with different thicknesses may be formed. Thereby, the releasing layer 120b conformed to the second side S2 of the 3D plastic layer 130b may have the undulating surface Sb.

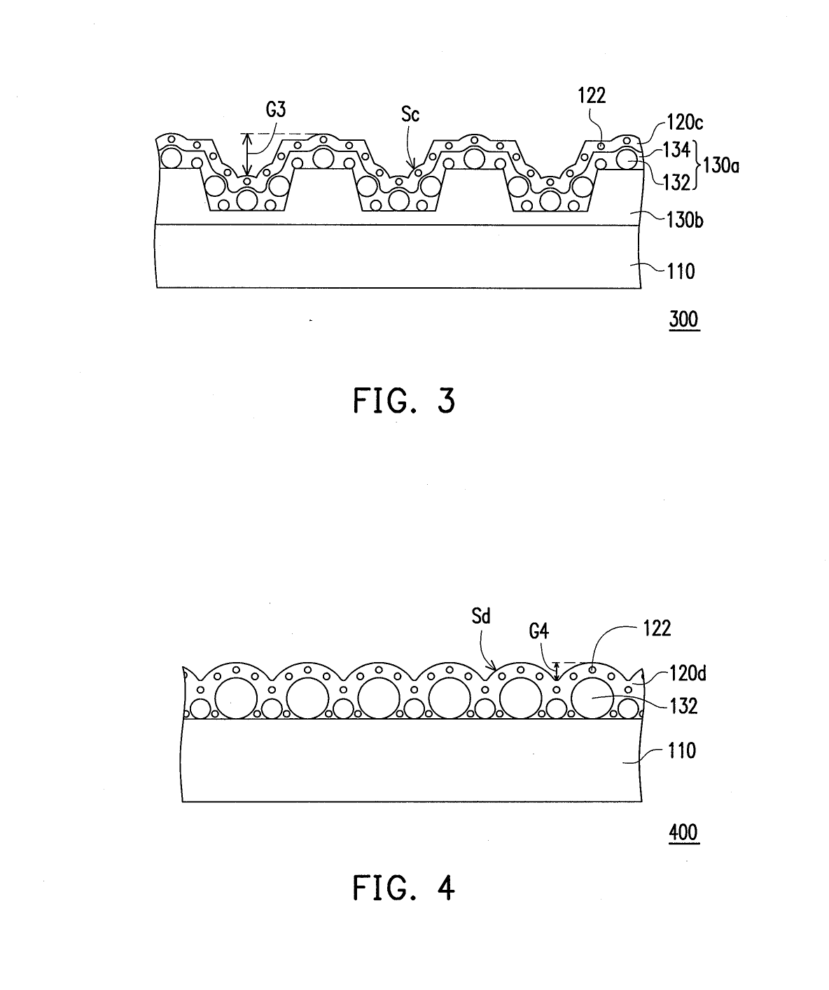

In another embodiment, the rough layer may be the stacked layer containing the 3D plastic layer 130b and the haze layer 130a described in the previous embodiment. With reference to FIG. 3, the decoration film 300 described in the present embodiment and the decoration films 100 and 200 respectively depicted in FIG. 1 and FIG. 2 have identical or similar components, and the same or similar reference numbers shown in FIG. 3, FIG. 2, and FIG. 1 represent the same or similar components or the same or similar characteristics of the components. The difference between the decoration film 300 and the decoration films 200 and 100 lies in that the rough layer described in the present embodiment is the stacked layer containing the haze layer 130a and the 3D plastic layer 130b. Under this configuration, the decoration film 300 described in the present embodiment may simultaneously have the characteristics of the decoration films 100 and 200. In brief, the decoration film 300 may, through the haze particles 132 of the haze layer 130a and the undulating structure of the 3D plastic layer 130b, provide an undulating structure with the height difference G3 that is different from the height differences G2 and G1.

Besides, in another embodiment of the invention, the releasing layer may be directly applied to provide the required surface structure. The details are elaborated with reference to FIG. 4 to FIG. 6. With reference to FIG. 4, the decoration film 400 described in the present embodiment includes a supporting layer 110 and a releasing layer 120d, and the releasing layer 120d is directly configured on the supporting layer 110, for instance. Different from the releasing layers 120a˜120c described in the previous embodiments, the releasing layer 120d described herein is substantially constituted by a haze material and a releasing material. The haze material includes the matrix material and the haze particles 132 described in the previous embodiments, and the releasing material may be referred to as that described hereinbefore and may include particles 122, extendable resin (not shown), a cross-linking agent (not shown), and a curing agent (not shown). The extendable resin may enhance the characteristics of extensibility and coverage of the releasing layer 120d, such that the decorated article formed by applying the decoration film 400 described in the present embodiment may have sharp edges and small corner angles. That is, the releasing layer 120d is conducive to improvement of the exterior design tolerance of the decorated article. In the present embodiment, the haze particles 132 allow the side of the releasing layer 120d away from the supporting layer 110 to have an undulating surface Sd.

The releasing layer 120d described in the present embodiment has the haze particles 132, and therefore the releasing layer 120d not only has the releasing properties but also provides the undulating surface structure. Hence, the releasing layer 120d may be considered as the rough layer that may achieve the releasing effect. To form the decoration film 400 described in the present embodiment, the releasing layer 120d may be formed on the supporting layer 110 through performing a one-time coating process, a one-time printing process, a one-time imprinting process, or a combination thereof. Namely, the decoration film 400 described in the present embodiment is conducive to the reduction of the manufacturing costs and the labor hour, and the restrictions on the supporting layer 110 may also be relaxed in the present embodiment.

From another perspective, the releasing layer 120d made of the haze material and the releasing material has the single-layer structure. Therefore, the releasing layer 120d may be printed onto the supporting layer 110 through intaglio printing with use of a flat mold or a cylindrical mold with different patterns, for instance. Alternatively, the releasing layer 120d may be printed onto the supporting layer 110 with use of a mold plate with at least two different depths, so that the releasing layer 120d with different thicknesses may be formed, and that the releasing layer 120d may have the surface structure with the height difference G4.

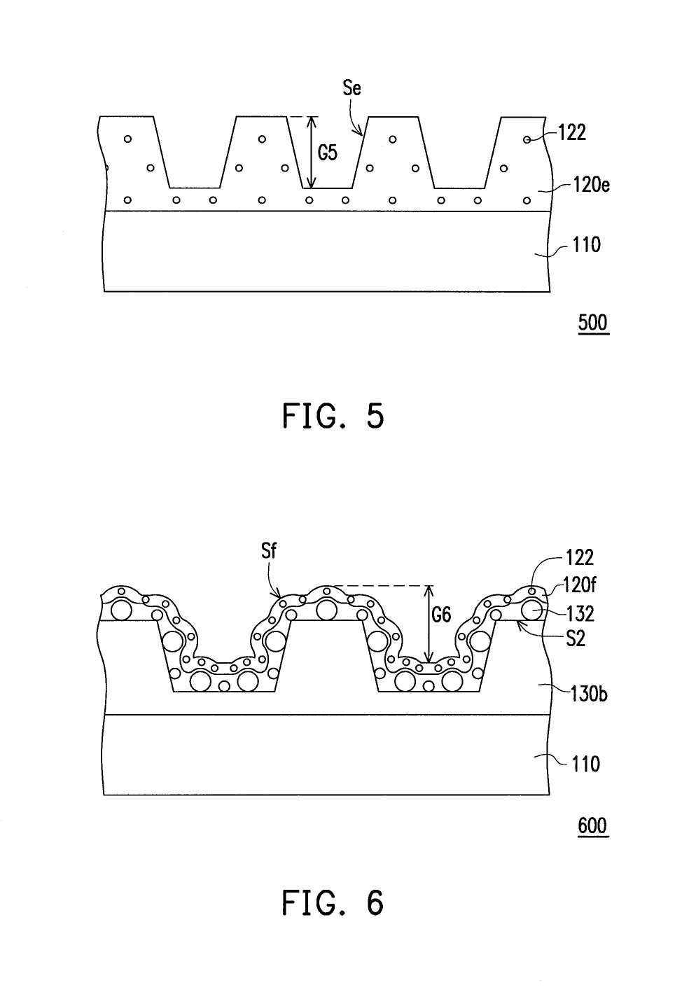

With reference to FIG. 5, the decoration film 500 described in the present embodiment is similar to the decoration film 400 depicted in FIG. 4 and includes a supporting layer 110 and a releasing layer 120e, and the releasing layer 120e is directly configured on the supporting layer 110, for instance. Different from the releasing layer 120d of the decoration film 400, the releasing layer 120e described in the present embodiment is substantially constituted by a material of a 3D plastic layer and a releasing material. Here, the material of the 3D plastic layer includes the PU resin, the melamine resin, or the mixture of the PU resin and the melamine resin described in the previous embodiment; the releasing material may be referred to as that described hereinbefore and may include particles 122, extendable resin (not shown), a cross-linking agent (not shown), and a curing agent (not shown).

To form the decoration film 500 described in the present embodiment, a one-time coating process, a one-time printing process, a one-time pressing process, or a combination thereof may be performed. The decoration film 500 described in the present embodiment is conducive to the reduction of the manufacturing costs and the labor hour, and the restrictions on the supporting layer may also be relaxed in the present embodiment.

From another perspective, the releasing layer 120e made of the material of the 3D plastic layer and the releasing material has the single-layer structure. Therefore, the releasing layer 120e may be printed onto the supporting layer 110 through intaglio printing with use of a flat mold or a cylindrical mold with different patterns, for instance. Alternatively, the releasing layer 120e may be printed onto the supporting layer 110 with use of a mold plate with at least two different depths, so that the releasing layer 120e with different thicknesses may be formed, and that the releasing layer 120e may have the surface structure with the height difference G5.

With reference to FIG. 6, the decoration film 600 described in the present embodiment and the decoration film 400 depicted in FIG. 4 have identical or similar components. The difference therebetween lies in that the decoration film 600 further includes a 3D plastic layer 130b that is disposed between the releasing layer 120f and the supporting layer 110, and a second side S2 of the 3D plastic layer 130b away from the supporting layer 110 has an undulating 3D surface. The releasing layer 120f is substantially conformed to the second side S2 (i.e., the 3D surface) of the 3D plastic layer 130b, such that the releasing layer 120f has an undulating surface Sf.

Under this configuration, the decoration film 600 described in the present embodiment may simultaneously have the characteristics of the 3D plastic layer 130b and the haze material. In brief, the decoration film 600 may, through the haze particles 132 and the undulating structure of the 3D plastic layer 130b, provide an undulating structure with the height difference G6.

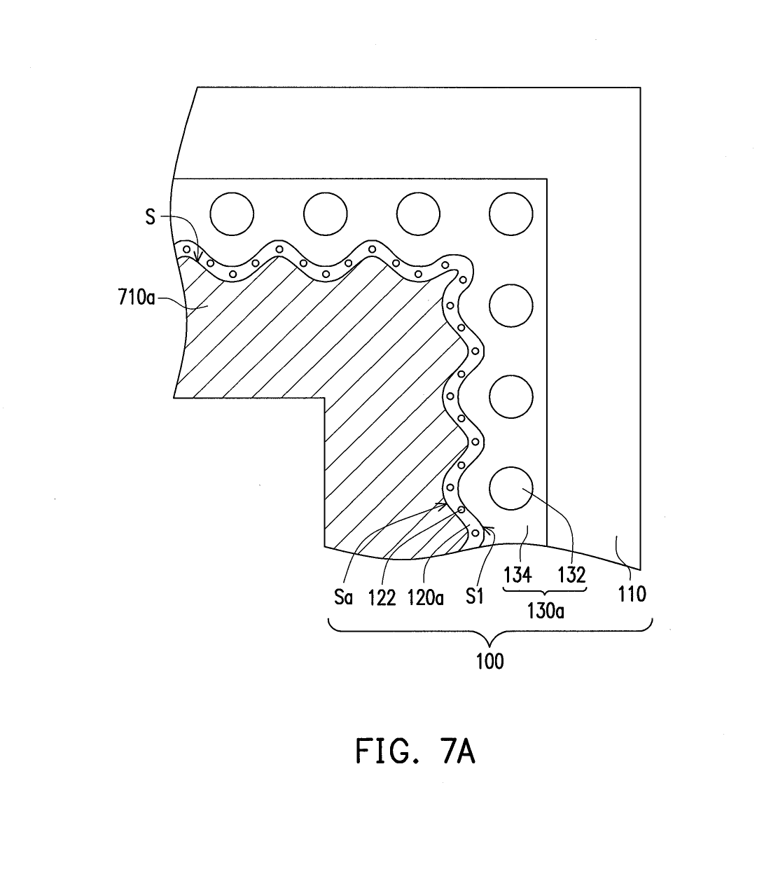

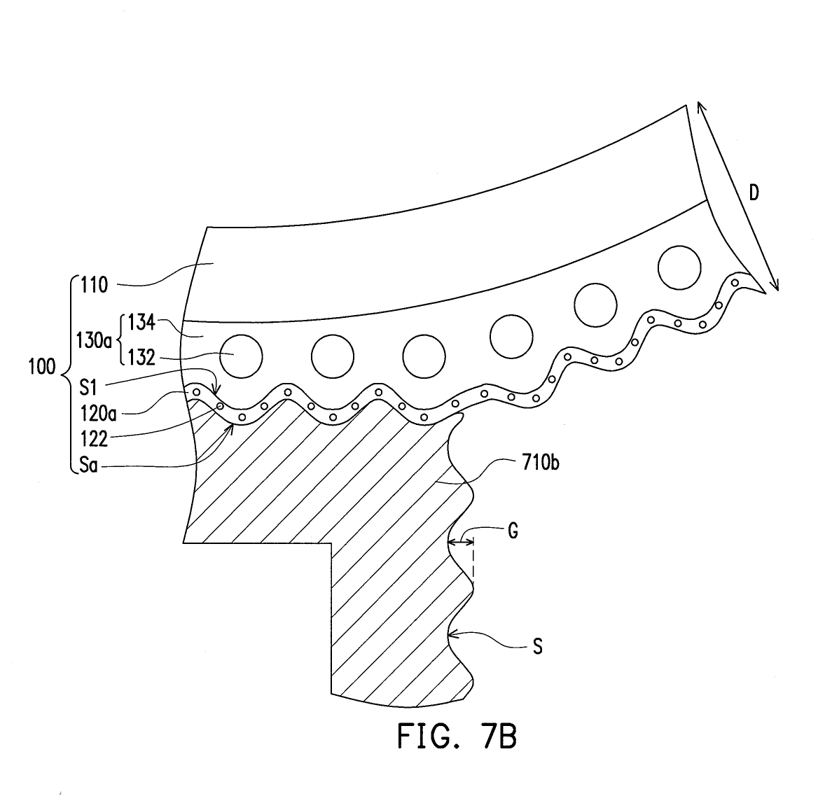

Said decoration film 100, 200, 300, 400, 500, or 600 may be employed when the IMR molding technology is applied, so as to form the decorated article. Detailed descriptions are provided hereinafter with reference to FIG. 7A and FIG. 7B.

FIG. 7A and FIG. 7B are schematic diagrams illustrating a process of manufacturing a decorated article according to an embodiment of the invention. As shown in FIG. 7A, one of the decoration films 100, 200, 300, 400, 500, and 600 is formed. The decoration film 100 is taken as an example in the following embodiment to illustrate the invention, which should not be construed as a limitation to the invention.

A body 710a is formed at a side (i.e., the undulating surface Sa) of the releasing layer 120a of the decorative film 100, and a surface S of the body 710a adjacent to the releasing layer 120a is substantially conformed to the undulating surface Sa of the releasing layer 120a and is another undulating surface.

According to the present embodiment, a method of forming the body 710a includes placing a plastic material at the side (i.e., the undulating surface Sa) of the releasing layer 120a away from the supporting layer 110. The plastic material includes polycarbonate, polypropylene, polymethylmethacrylate, MMA-St, acrylonitrile butadiene styrene, polystyrene, polyethylene terephthalate, polyoxymethylene, or a combination thereof. Besides, a method of placing the plastic material at the side of the releasing layer 120a away from the supporting layer 110 includes injection molding, thermoforming, compression molding, blow molding, compression, and so on. For instance, during the injection molding process, the decoration film 100 is placed inside a mold and a thermally melted plastic material is injected into the mold at a side of the decoration film 100, such that the thermally melted plastic material and the decoration film 100 may be combined, and that the decoration film 100 may be adhered onto the body 710a.

As shown in FIG. 7B, after the surface structure of the decoration film 100 is transferred onto the body 710a made of the thermally melted plastic material, the releasing layer 120a that may achieve the releasing effect is torn off, herein the decoration film 100 is completely removed from the body 710a to form the decorated article 710b. Particularly, during this step, the surface S of the body 710a adjacent to the releasing layer 120a is separated from the undulating surface Sa of the releasing layer 120a. Thereby, the IMR molding process is completed. Here, the releasing material of the releasing layer 120a includes the extendable resin that may improve the releasing capability. Hence, when the decoration film 100 is completely removed from the body 710a to form the decorated article 710b, the broken film and surface cracks of the film may be avoided.

Before the decoration film 100 is completely removed from the body 710a, the surface S of the body 710a adjacent to the releasing layer 120a is substantially conformed to the undulating surface Sb of the releasing layer 120a. Therefore, after the decoration film 100 is completely removed from the body 710a, the decorated article 710b has an undulating height difference G.

Since the number of film layers in the decoration film 100, 200, 300, 400, 500, or 600 is not significant, the decorated article formed by applying the decoration film 100, 200, 300, 400, 500, or 600 may have favorable transfer-printing adaptability. Here, the transfer-printing adaptability refers to the effect of transfer-printing the decoration film 100, 200, 300, 400, 500, or 600 respectively having the height difference G1, G2, G3, G4, G5, or G6 onto the decorated article. In other words, the greater the transfer-printing adaptability, the less difference between the undulating height difference G of the decorated article and the height difference G1, G2, G3, G4, G5, or G6. According to the normal IMR technology, the undulating height difference of the decorated article may at most reach 25 vim due to the excessive number of film layers in the decoration film. By contrast, the undulating height difference G of the decorated article formed by the decoration film 100, 200, 300, 400, 500, or 600 as described in the previous embodiments may at least reach 40 μm. That is, if the decoration film 100, 200, 300, 400, 500, or 600 described in the previous embodiment is employed, the resultant decorated article may be able to comply with the relatively strict restrictions. Certainly, in the present embodiment, the value of the undulating height difference G is not limited, and the decorated article formed by employing the decoration film 100, 200, 300, 400, 500, or 600 may have favorable transfer-printing adaptability. In addition, the undulating height difference G not only provides the decorated article with the undulating structure but also enables the decorated article to achieve different tactile and visual effects. Specifically, the undulating height difference G may enable light with different wavelengths to be reflected or refracted in different directions, so as to generate the light gradient effect or the foggy effect.

Moreover, since the number of film layers in the decoration film 100, 200, 300, 400, 500, or 600 is not significant, and the releasing material includes the extendable resin that may enhance the characteristics of extensibility and coverage, the decorated article formed by employing the decoration film 100, 200, 300, 400, 500, or 600 may have sharp edges and small corner angles. In other words, the corner design of the decorated article is not limited to round angles. Therefore, the exterior design tolerance of the decorated article is relatively high.

To sum up, in the embodiments of the invention, a decoration film with relatively fewer film layers is provided, such that the decoration film may have the relatively small thickness. Further, the decoration film described herein is conducive to the reduction of the manufacturing costs and the labor hour, the restrictions on the supporting layer may also be relaxed, and the exterior design tolerance (e.g., the design of edges and corner angles) of the decorated article is increased. In addition, the releasing material of the releasing layer includes a plurality of particles which may enhance the releasing capability of the releasing layer. Moreover, the releasing material of the releasing layer includes the extendable resin that may enhance the characteristics of extensibility and coverage of the releasing layer, and thereby the decorated article formed by employing the decoration film may have high design tolerance (e.g., the design of edges and corner angles can have various changes). According to several embodiments of the invention, the rough layer of the decoration film or the undulating structure directly formed on the releasing layer may enable the resultant decorated article to achieve different tactile and visual effects (e.g., light and shadow, matte effects, and so on).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film comprising:
a supporting layer; and
a releasing layer disposed on the supporting layer, wherein a releasing material of the releasing layer comprises an extendable resin and a plurality of particles, and a side of the releasing layer, away from the supporting layer, has an undulating surface.

2. The decoration film as recited in claim 1, further comprising a rough layer, wherein the supporting layer and the releasing layer are located at two respective sides of the rough layer.

3. The decoration film as recited in claim 2, wherein the rough layer is a haze layer, a three-dimensional plastic layer, or a stacked layer containing the haze layer and the three-dimensional plastic layer.

4. The decoration film as recited in claim 3, wherein the haze layer comprises a plurality of haze particles, the haze particles equip a first side of the haze layer away from the supporting layer with an undulating haze surface, and the releasing layer is substantially conformed to the first side of the haze layer, so as to have the undulating surface.

5. The decoration film as recited in claim 3, wherein the haze layer further comprises a matrix made of a material selected from the group consisting of polyurethane, polymethylmethacrylate, epoxide, and polyester.

6. The decoration film as recited in claim 3, wherein a material of the three-dimensional plastic layer is selected from polyurethane resin, melamine resin, or a mixture of polyurethane resin and melamine resin, a second side of the three-dimensional plastic layer away from the supporting layer has an undulating three-dimensional surface, and the releasing layer is substantially conformed to the second side of the three-dimensional plastic layer, so as to have the undulating surface.

7. The decoration film as recited in claim 1, wherein the releasing material further comprises a haze material selected from the group consisting of polyurethane, polymethylmethacrylate, epoxide, and polyester.

8. The decoration film as recited in claim 7, wherein the haze material further comprises a plurality of haze particles, and the haze particles equip the side of the releasing layer, away from the supporting layer, with the undulating surface.

9. The decoration film as recited in claim 7, further comprising a three-dimensional plastic layer, wherein the supporting layer and the releasing layer are located at two respective sides of the three-dimensional plastic layer.

10. The decoration film as recited in claim 1, wherein a material of the releasing layer further comprises a material of a three-dimensional plastic layer, and the material of the three-dimensional plastic layer is selected from polyurethane resin, melamine resin, or a mixture of polyurethane resin and melamine resin.

11. The decoration film as recited in claim 1, wherein a material of the supporting layer includes polyethylene terephthalate, polycarbonate, polyvinyl chloride, or polymethyl methacrylate.

12. The decoration film as recited in claim 1, wherein a material of the particles is selected from the group consisting of silicon dioxide, calcium carbonate, calcium sulfate, barium sulfate, aluminum oxide, and titanium oxide, and a shape of the particles is circular or irregular.

13. The decoration film as recited in claim 1, wherein a material of the releasing layer further comprises a cross-linking agent and a curing agent.

14. The decoration film as recited in claim 13, wherein the cross-linking agent is selected from isocyanate.

15. The decoration film as recited in claim 13, wherein the curing agent is selected from epoxy resin.

16. The decoration film as recited in claim 1, wherein the extendable resin comprises polyurethane resin, melamine resin, or a mixture of polyurethane resin and melamine resin.

17. A method for manufacturing a decorated article, the method comprising:
forming the decoration film as recited claim 1;
forming a body at the side of the releasing layer of the decorative film, a surface of the body adjacent to the releasing layer being substantially conformed to the side of the releasing layer and being an undulating surface; and
removing the entire decorative film away from the body to form the decorated article.

18. The method as recited in claim 17, wherein a method of forming the body comprises placing a plastic material at the side of the releasing layer away from the supporting layer.

19. The method as recited in claim 18, wherein the plastic material is selected from the group consisting of polycarbonate, polypropylene, polymethylmethacrylate, MMA-St, acrylonitrile butadiene styrene, polystyrene, polyethylene terephthalate, and polyoxymethylene.

20. The method as recited in claim 17, wherein a surface of the decorated article has an undulating height difference at least reaching about 40 μm.
